(19) United States
(12) Patent Application Publication
(10) Pub. No.: US 2026/0234374 A1
(43) Pub. Date: Aug. 13, 2026

(54) CELLULOSE-BASED RESIN COMPOSITION AND MOLDED BODY USING THE SAME

(71) Applicants: NEC Corporation, Tokyo (JP); NEC Platforms, Ltd, Kanagawa (JP)

(72) Inventors: Yuto SANO, Tokyo (JP); Kiyohiko TOYAMA, Tokyo (JP); Shukichi TANAKA, Tokyo (JP); Midori SHIMURA, Tokyo (JP); Takuma OZAWA, Tokyo (JP)

(73) Assignees: NEC Corporation, Tokyo (JP); NEC Platforms, Ltd, Kanagawa (JP)

(21) Appl. No.: 19/469,448

(22) PCT Filed: Apr. 4, 2024
(86) PCT No.: PCT/JP2024/013945

§ 371 Date: Sep. 26, 2025

(30) Foreign Application Priority Data
Apr. 5, 2023 (JP) 2023-061235
Mar. 29, 2024 (JP) 2024-057964

(51) Int. Cl. C08L 1/12; B29C 45/00; B29K 1/00; B29K 71/00; B29K 509/08; C08K 3/32; C08K 5/11; C08K 5/29; C08K 5/3492; C08K 5/523; C08K 7/14

(52) U.S. Cl. CPC C08L 1/12; B29C 45/0001; C08K 3/32; C08K 5/11; C08K 5/29; C08K 5/34922; C08K 5/523; C08K 7/14; B29K 2001/12; B29K 2071/00; B29K 2509/08; C08K 2003/323

(57) ABSTRACT

Provided is a cellulose-based resin composition able to form a molded body having excellent flame retardancy and strength. This cellulose-based resin composition contains component A, cellulose acetate, component B, a plasticizer, and component C, a nitrogen-containing flame retardant. The content of the component B is 20-40 mass % relative to a total of 100 mass % of the components A and B. The content of the component C is 5-35 mass % relative to a total of 100 mass % of the components A, B and C. Also provided is a cellulose-based resin composition that contains component A, cellulose acetate, component B, a plasticizer (excluding component D), component C, a flame retardant (excluding components B and D), and component D, a phosphorus-containing organic compound.

### TECHNICAL FIELD

The present disclosure relates to a cellulose acetate resin composition made from non-edible cellulose as a raw material, and a molded body using the same.

### BACKGROUND ART

Bioplastics, which are made from renewable organic resources such as plants, can contribute to countering oil depletion and global warming, and are therefore beginning to be used in durable products such as electronic devices and automobiles, in addition to general products such as packaging, containers, and textiles. In particular, there is a demand for the development of new bioplastics made from non-edible plant resources due to concerns about future food shortages.

A representative example of a non-edible plant resource is cellulose, which is a major component of wood and plants. Various bioplastics have been developed and commercialized using cellulose esters, such as cellulose acetate, cellulose acetate propionate, cellulose acetate butyrate, and cellulose acetate phthalate.

On the other hand, in order to apply a resin composition based on cellulose ester to applications requiring a high degree of flame retardancy, such as electronic devices, flame retardant measures are necessary, and it is known to add a flame retardant to the resin composition.

For example, Patent Document 1 describes a resin composition comprising a cellulose ester, a thermoplastic resin having an aromatic ring in the main chain, a plasticizer comprising a polymer having a repeating structural unit and a number average molecular weight of 500 to 5,000, and a phosphorus-containing flame retardant having a molecular weight of 400 to 1,500.

### CITATION LIST

### Patent Document

Patent Document 1: JP2011-225841A

### SUMMARY OF INVENTION

### Problems to be Resolved by the Invention

However, in a molded body formed using a resin composition based on cellulose ester, it has been difficult to achieve both flame retardancy and mechanical strength (such as impact resistance).

In view of the above-mentioned problems, an object of the present disclosure is to provide a cellulose-based resin composition capable of forming a molded body having excellent flame retardancy and strength.

### Means of Solving the Problems

In order to achieve the above-mentioned problem, the present disclosure relates to:

A cellulose-based resin composition comprising:
a component A: cellulose acetate;
a component B: a plasticizer;
a component C: a nitrogen-containing flame retardant;
wherein the content of the component B is 20 to 40 mass % relative to 100 mass % of the total content of the components A and B, and
the content of the component C is 5 to 35 mass % relative to 100 mass % of the total content of the components A, B and C.

The present disclosure also relates to:

A cellulose-based resin composition comprising:
a component A: cellulose acetate;
a component B: a plasticizer (excepting a component D);
a component C: a flame retardant (excepting the component B and the component D); and
a component D: a phosphorus-containing organic compound.

### Advantageous Effect of Invention

According to the present disclosure, it is possible to provide a cellulose-based resin composition capable of forming a molded body having excellent flame retardancy and strength.

### MODE FOR CARRYING OUT THE INVENTION

### [1] Part 1

### [Resin Composition]

The resin composition of the present disclosure is
a cellulose-based resin composition comprising:
a component A: cellulose acetate;
a component B: a plasticizer;
a component C: a nitrogen-containing flame retardant;
wherein the content of the component B is 20 to 40 mass % relative to 100 mass % of the total content of the components A and B, and
the content of the component C is 5 to 35 mass % relative to 100 mass % of the total content of the components A, B and C.

### <Component A: Cellulose Acetate>

The resin composition of the present disclosure comprises cellulose acetate as a component A. As cellulose acetate, one in which acetyl groups have been introduced into at least a portion of the hydroxyl groups of cellulose as a raw material can be used.

Cellulose is a linear polymer formed by polymerization of β-D-glucose molecules (β-D-glucopyranose) via β (1→4) glycosidic bonds, as shown in the following formula (1) (wherein n in the formula is a natural number).

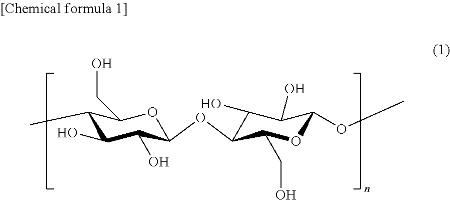

Cellulose is a main component of vegetation, and is obtained by separating other components such as lignin from vegetation. In addition to those obtained in this way, cotton (for example, cotton linters) and pulp (for example, wood pulp) having high cellulose content can be used after purification or as they are. As for the shape, size, and form of the cellulose or a derivative thereof used as a raw material, it is preferable to use cellulose in a powder form having an appropriate particle size and particle shape from the viewpoint of reactivity, solid-liquid separation, and handleability. For example, a fibrous material or a powdery material having a diameter of 1 to 100 μm (preferably 10 to 50 μm) and a length of 10 μm to 100 mm (preferably 100 μm to 10 mm) can be used.

The cellulose has a polymerization degree preferably in the range of 50 to 5,000, more preferably 100 to 3,000, and still more preferably 100 to 1,000 as the polymerization degree of glucose (average polymerization degree). If the polymerization degree is too low, the produced resin may have insufficient strength, heat resistance, and the like. In contrast, if the polymerization degree is too high, the produced resin may have too high a melt viscosity, which may affect the molding.

Each glucose unit that constitutes cellulose has three hydroxy groups. Cellulose acetate in the present disclosure is obtained by introducing acetyl groups into cellulose using these hydroxy groups. Introduction of acetyl groups into cellulose can reduce the intermolecular force (intermolecular bond) of cellulose, and can improve the plasticity of the resin composition.

The acetyl groups can be introduced by a reaction of hydroxy groups in cellulose with an acylating agent. The acetyl groups serve as an organic group moiety introduced in place of hydrogen atoms of the hydroxy groups of cellulose. The acylating agent is a compound having at least one functional group capable of reacting with hydroxy groups in cellulose, and examples thereof include compounds having a carboxyl group, a carboxylic acid halide group, and a carboxylic acid anhydride group. Specific examples include aliphatic monocarboxylic acids, acid halides thereof, and acid anhydrides thereof.

The average number of introduced acetyl groups (DS_{Ac}) per glucose unit of cellulose (acetyl group introduction rate), in other words, the average number of hydroxy groups substituted by acetyl groups per glucose unit (degree of hydroxy group substitution) can be set within the range of 0.1 to 3.0. From the viewpoint of sufficiently obtaining the effect of introducing acetyl groups, in particular, from the viewpoint of water resistance, fluidity, and the like, the DS_{Ac} is preferably equal to or more than 2.0, more preferably equal to or more than 2.2, and still more preferably equal to or more than 2.4. From the viewpoint of sufficiently obtaining the effect of other groups (hydroxy groups and the like) while obtaining the effect of introducing acetyl groups, the DS_{Ac} is preferably equal to or less than 2.9, and more preferably equal to or less than 2.8.

The larger the amount of the remaining hydroxy groups is, the higher the maximum strength and heat resistance of the resin composition tend to be, but the higher the water absorbency tends to be. On the other hand, as the conversion rate (degree of substitution) of hydroxy groups is higher, the water absorbency tends to decrease, leading to an increase in the plasticity and breaking strain, while the maximum strength and heat resistance tend to decrease. The conversion rate of hydroxy groups can be appropriately set in consideration of these tendencies and the like.

The average number of remaining hydroxy groups per glucose unit (residual degree of hydroxy groups) of cellulose acetate can be set within the range of 0 to 2.9. Hydroxy groups may remain from the viewpoint of the maximum strength, heat resistance, and the like of the resin composition, and for example, the residual degree of hydroxy groups may be equal to or more than 0.01, and may further be equal to or more than 0.1. In particular, from the viewpoint of fluidity of the resin composition, the residual degree of hydroxy groups of the finally produced cellulose acetate is preferably equal to or less than 1.0, still more preferably equal to or less than 0.8, and particularly preferably equal to or less than 0.6. From the viewpoint of water resistance, impact resistance, and the like in addition to fluidity of the resin composition, the residual degree of hydroxy groups is preferably equal to or less than 0.6, more preferably equal to or less than 0.5, still more preferably equal to or less than 0.4, and particularly preferably equal to or less than 0.2.

The molecular weight of cellulose acetate is preferably within the range of 10,000 to 400,000, more preferably within the range of 50,000 to 350,000, still more preferably within the range of 100,000 to 300,000, and even still more preferably within the range of 150,000 to 250,000 as the weight-average molecular weight. If the molecular weight is too high, the resin composition may exhibit low fluidity, resulting in difficulties in uniform mixing as well as in processing. In contrast, if the molecular weight is too low, physical properties such as impact resistance of the resin composition may be deteriorated. The weight-average molecular weight can be determined by gel permeation chromatography (GPC) (commercially available standard polystyrene can be used as a standard sample).

In the resin composition of the present disclosure, the content of the component A is not particularly limited, and is preferably equal to or more than 35 mass %, more preferably equal to or more than 50 mass %, and particularly preferably equal to or more than 60 mass % based on 100 mass % of the total content of the component A, component B, and component C. The content is also preferably equal to or less than 90 mass %, more preferably equal to or less than 85 mass %, and particularly preferably equal to or less than 80 mass %, based on 100 mass % of the total content of the component A, component B, and component C.

### <Component B: Plasticizer>

The resin composition of the present disclosure contains a plasticizer as the component B. The component B may be used singly or in combination of two or more thereof. The component B can impart processing stability to the resin composition. Examples of the component B include, but are not limited to, one or more phosphate esters selected from the group consisting of triphenyl phosphate, triethyl phosphate, tributyl phosphate, tricresyl phosphate, cresyl di-2,6-xylenyl phosphate, and a compound represented by the following Formula (2).

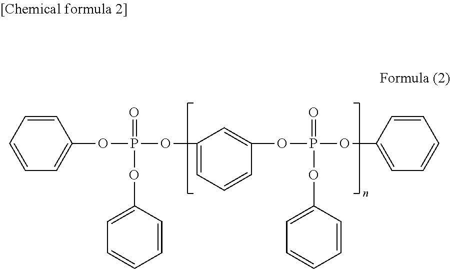

(n is an integer equal to or greater than 1)

In the above-described Formula (2), n is an integer of 1 or more, preferably 1 to 3, and more preferably n=1. The use of these predetermined phosphate esters enables the formation of a resin composition having high strength.

In one aspect of the present disclosure, the component B is more preferably triphenyl phosphate from the viewpoint of flame retardancy and high compatibility with cellulose acetate. Triphenyl phosphate is less likely to volatilize and has high compatibility with the component A.

In the resin composition of the present disclosure, as the plasticizer of the component B, part or all of the phosphate esters can be substituted with a polyether ester-based plasticizer in consideration of moldability and the like.

In the resin composition of the present disclosure, the content of the component B is 20 to 40 mass %, preferably 22 to 35 mass %, and more preferably 22.5 to 30 mass %, based on 100 mass % of the total content of the component A and component B. When the content of the component B is within the range, it is possible to obtain, by using the resin composition, a molded body that exhibits excellent flame retardancy and strength and has minimized exudation (bleed-out). If the content of the component B is too large, exudation from the molded body may occur in a high temperature and high humidity environment, and if the content of the component B is too small, the strength may be insufficient.

The resin composition of the present disclosure can contain other plasticizers in addition to the above-described plasticizer as long as the effect of the present disclosure is not impaired. Examples of the other plasticizers include adipate esters such as dioctyl adipate and diisononyl adipate; phthalate esters such as dibutyl phthalate, diaryl phthalate, diethyl phthalate, dimethyl phthalate, di-2-methoxyethyl phthalate, ethyl phthalyl ethyl glycolate, and methyl phthalyl ethyl glycolate; tartrate esters such as dibutyl tartrate; polyhydric alcohol esters such as triacetin, diacetyl glycerin, tripropionitrile glycerin, and glycerin monostearate; dialkyl esters of aliphatic dicarboxylic acids such as dibutyl adipate, dioctyl adipate, dibutyl azelate, dioctyl azelate, and dioctyl sebacate; citrate esters such as triethyl citrate, acetyl triethyl citrate, and acetyl tributyl citrate; epoxidized vegetable oils such as epoxidized soybean oil and epoxidized linseed oil; castor oil and its derivatives; benzoate esters such as ethyl o-benzoylbenzoate; aliphatic dicarboxylic acid esters such as sebacate esters and azelate esters; unsaturated dicarboxylic acid esters such as maleate esters; and other plasticizers such as N-ethyl toluenesulfonamide, o-cresyl p-toluenesulfonate, and tripropionin.

### <Component C: Nitrogen-Containing Flame Retardant>

The resin composition of the present disclosure contains a nitrogen-containing flame retardant as the component C. The component C may be used singly or in combination of two or more thereof. In the present disclosure, it has been found that the use of a nitrogen-containing flame retardant not only provides excellent flame retardancy but also significantly improves the strength as compared with the use of other flame retardants.

Examples of the component C include, but are not limited to, one or more selected from the group consisting of ammonium polyphosphate, melamine sulfate, guanidine phosphate, melamine polyphosphate, piperazine pyrophosphate, and melamine cyanurate. The component C is more preferably at least one selected from ammonium polyphosphate, guanidine phosphate, and melamine sulfate, and is particularly preferably ammonium polyphosphate from the viewpoint of flame retardancy and strength. Furthermore, ammonium polyphosphate microencapsulated with a melamine resin or the like can be used from the viewpoint of improving water resistance.

In the resin composition of the present disclosure, the content of the component Cis 5 to 35 mass %, preferably 5 to 30 mass %, and more preferably 7 to 25 mass %, based on 100 mass % of the total content of the component A, component B, and component C. When the content of the component C is within the range, it is possible to obtain, by using the resin composition, a molded body that exhibits excellent flame retardancy and strength. If the content of the component C is too large, moldability may be deteriorated or toughness (Charpy impact value) may be deteriorated. If the content of the component C is too small, the strength may be insufficient.

### <Flame Retardant Aid (Anti-Drip Agent)>

The resin composition of the present disclosure preferably further contains a flame retardant aid. The inclusion of the flame retardant aid prevents flame propagation caused by shrinkage of the resin composition and melt dropping (dripping) of the resin during heating. The flame retardant aid is preferably a fluorine-based flame retardant aid (fluorine-containing polymer), and more preferably contains a fluorine-containing polymer that forms a fiber structure (fibrillar structure) in the resin composition. It is possible to enhance the effect of minimizing the dripping phenomenon during combustion by blending the fluorine-containing polymer.

Examples of the flame retardant aid include polytetrafluoroethylene, a tetrafluoroethylene-based copolymer (for example, a tetrafluoroethylene/hexafluoropropylene copolymer or the like), fluorine-based resins such as acrylic-modified polytetrafluoroethylene, polyvinylidene fluoride, and polyhexafluoropropylene, and perfluoroalkanesulfonic acid alkali metal salt compounds and perfluoroalkanesulfonic acid alkaline earth metal salts such as sodium perfluoromethanesulfonate, potassium perfluoro-n-butanesulfonate, potassium perfluoro-t-butanesulfonate, sodium perfluorooctanesulfonate, and calcium perfluoro-2-ethylhexanesulfonate. As the fluorine-containing polymer, various forms of fluoropolymers such as a fluoropolymer in a fine powder form, a fluoropolymer aqueous dispersion, a mixture of a fluoropolymer in a powder form and an acrylonitrile-styrene copolymer, and a mixture of a fluoropolymer in a powder form and polymethyl methacrylate can also be used. Similarly, silicone compounds such as silicone rubbers and layered silicates such as talc may be blended as the other flame retardant aids. These may be used singly or in combination of two or more thereof.

Among these, a fluorine-based flame retardant aid having a fibril forming ability is preferable, and polytetrafluoroethylene is particularly preferable. The molecular weight of the fluorine-based flame retardant aid (particularly, polytetrafluoroethylene) is preferably 1,000,000 to 10,000,000 and more preferably 2,000,000 to 9,000,000 in terms of a number-average molecular weight determined from a standard specific gravity. Such polytetrafluoroethylene may be in the form of a solid or an aqueous dispersion.

In the resin composition of the present disclosure, the content of the flame retardant aid may be 0 mass %, but is preferably equal to or more than 0.01 mass %, more preferably equal to or more than 0.1 mass %, more preferably equal to or more than 0.2 mass %, and still more preferably equal to or more than 0.3 mass %, and is preferably equal to or less than 2 mass %, more preferably equal to or less than 1.5 mass %, and still more preferably equal to or less than 1.0 mass %, based on 100 mass % of the total amount of the resin composition. When the content of the flame retardant aid is within the range, the flame retardancy is further improved.

### <Inorganic or Organic Granular or Fibrous Fillers>

The resin composition of the present disclosure preferably contains an inorganic- or organic-based particulate or fibrous filler. Addition of the filler can further improve the strength. Examples of the filler include mineral matter particles (such as talc, mica, calcined siliceous earth, kaolin, sericite, bentonite, smectite, clay, silica, quartz powder, glass beads, glass powder, glass flakes, milled fibers, and wollastonite), boron-containing compounds (such as boron nitride, boron carbide, and titanium boride), metal carbonates (such as magnesium carbonate, heavy calcium carbonate, and light calcium carbonate), metal silicates (such as calcium silicate, aluminum silicate, magnesium silicate, and magnesium aluminosilicate), metal oxides (such as magnesium oxide), metal sulfates (such as calcium sulfate and barium sulfate), metal carbides (such as silicon carbide, aluminum carbide, and titanium carbide), metal nitrides (such as aluminum nitride, silicon nitride, and titanium nitride), white carbon, and various metal foils. Examples of the fibrous filler include organic fibers (such as natural fibers and paper), inorganic fibers (such as glass fibers, asbestos fibers, carbon fibers, silica fibers, silica alumina fibers, wollastonite, zirconia fibers, and potassium titanate fibers), and metal fibers.

In one aspect of the present example embodiment, the resin composition preferably contains glass fiber. Inclusion of the glass fiber in the resin composition improves the strength of the molded body. The glass fiber is not particularly limited, but the fiber length of the glass fiber is preferably equal to or more than 0.5 mm, and preferably equal to or less than 30 mm and more preferably equal to or less than 10 mm in the shape before melt-kneading. The cross-sectional shape of the glass fiber is not particularly limited, and examples thereof include a circular shape, an elliptical shape, an oval shape, and a non-circular shape. The fiber diameter of the glass fiber may be, for example, 3 to 20 μm when the cross-sectional area is converted into a perfect circle. In one aspect of the present example embodiment, the content of the glass fiber based on the total mass of the resin composition may be 0 mass %, but is, for example, preferably equal to or more than 0.5 mass %, more preferably equal to or more than 1 mass %, and still more preferably equal to or more than 3 mass %, and is preferably equal to or less than 20 mass %, more preferably equal to or less than 10 mass %, and still more preferably equal to or less than 8 mass %.

In the resin composition of the present disclosure, the content of the filler may be 0 mass %, but is preferably equal to or more than 1 mass %, more preferably equal to or more than 2 mass %, and particularly preferably equal to or more than 3 mass %, based on 100 mass % of the total amount of the resin composition. The content is preferably equal to or less than 10 mass %, more preferably equal to or less than 8 mass %, and particularly preferably equal to or less than 5 mass % based on 100 mass % of the total amount of the resin composition. When the content of the filler is within the range, the effect of improving the strength of the resin composition can be sufficiently obtained. These fillers can be used singly or in combination of two or more thereof.

### <Hydrolysis Inhibitor>

In one aspect of the present example embodiment, the resin composition may contain a hydrolysis inhibitor. The hydrolysis inhibitor refers to a compound capable of reacting with a carboxylic acid generated by hydrolysis of cellulose acetate or polyester. Inclusion of the hydrolysis inhibitor in the resin composition can improve the durability and the like of the molded body.

Examples of the hydrolysis inhibitor include compounds having functional groups such as a carbodiimide group, an epoxy group, and an oxazoline group, and a carbodiimide compound having a carbodiimide group is preferable.

The carbodiimide compound is a compound having one or more carbodiimide groups (—N═C═N—) in the molecule. The carbodiimide compound may be a compound containing two or more carbodiimide groups in the molecule, that is, a polyvalent carbodiimide compound. In one aspect, the number of carbodiimide groups in the polyvalent carbodiimide compound is preferably equal to or less than 30 in the carbodiimide compound. As the carbodiimide compound, a high molecular weight polycarbodiimide produced by a decarboxylative condensation reaction of diisocyanate in the presence of a carbodiimide catalyst may be used.

Examples of the carbodiimide compound include monocarbodiimides such as aliphatic monocarbodiimide, alicyclic monocarbodiimide, and aromatic monocarbodiimide, and polycarbodiimides such as aliphatic polycarbodiimide, alicyclic polycarbodiimide, and aromatic polycarbodiimide.

Examples of the aliphatic monocarbodiimide include diisopropylcarbodiimide, dimethylcarbodiimide, diisobutylcarbodiimide, and dioctylcarbodiimide.

Examples of the alicyclic monocarbodiimide include dicyclohexylcarbodiimide.

Examples of the aromatic monocarbodiimide include N,N′-diphenylcarbodiimide and N,N′-di-2,6-diisopropylphenylcarbodiimide.

Examples of the polycarbodiimide include those obtained by decarboxylative condensation reaction of the following diisocyanates. Examples of the diisocyanates include 1,4-phenylene diisocyanate, 1,3,5-triisopropyl-phenylene-2,4-diisocyanate, 4,4′-diphenylmethane diisocyanate, 3,3′-dimethoxy-4,4′-diphenylmethane diisocyanate, 3,3′-dimethyl-4,4′-diphenylmethane diisocyanate, 4,4′-diphenylether diisocyanate, 3,3′-dimethyl-4,4′-diphenylether diisocyanate, 2,4-tolylene diisocyanate, 2,6-tolylene diisocyanate, 1-methoxyphenyl-2,4-diisocyanate, isophorone diisocyanate, 4,4′-dicyclohexylmethane diisocyanate, and tetramethylxylylene diisocyanate, and these can be used singly or in combination of two or more thereof. Such a high molecular weight polycarbodiimide may be synthesized, or a commercially available product may be used.

The number-average molecular weight of the polycarbodiimide is not particularly limited, but for example, it is preferable to use a polycarbodiimide having a number-average molecular weight of preferably equal to or more than 200, more preferably equal to or more than 300, and preferably equal to or less than 20,000.

The carbodiimide compound may be a carbodiimide compound having an isocyanate group in the molecule or a carbodiimide compound having no isocyanate group in the molecule, and can be appropriately selected. In the polycarbodiimide, both ends of the molecule or any moiety in the molecule may have a functional group such as an isocyanate group, or may have a molecular structure different from other portions such as a branched molecular chain. In addition, the carbodiimide compound may have a heterocyclic ring or another functional group in the molecule.

As the carbodiimide compound, a commercially available product may be used, and examples thereof include CARBODILITE (registered trademark) series (for example, CARBODILITE HMV-15CA, HMV-5CA-LC, LA-1) manufactured by Nisshinbo Chemical Inc.; STABAXOL I POWDER, STABAXOL P, and STABAXOL P 100 manufactured by LANXESS AG; and TCC-NP manufactured by Teijin Limited.

Examples of a compound containing an epoxy group include a glycidyl ester compound and a glycidyl ether compound. Examples of a compound containing an oxazoline group include bisoxazoline compounds.

The content of the hydrolysis inhibitor may be 0 mass %, but is, for example, preferably equal to or more than 0.1 mass % and more preferably equal to or more than 0.5 mass %, and preferably equal to or less than 5 mass % and more preferably equal to or less than 3 mass %, based on 100 mass % of the total amount of the resin composition. The hydrolysis inhibitors may be used singly or in combination of two or more thereof.

### <Colorant>

In one aspect of the present disclosure, the resin composition may contain a colorant such as a black colorant. The content of the colorant such as a black colorant can be set within the range of, for example, 0.01 to 10 phr based on the total mass of the components other than the colorant (the content of the colorant is 0.01 to 10 parts by mass based on 100 parts by mass in the total mass of the components of the resin composition other than the colorant), but not limited thereto. From the viewpoint of obtaining a sufficient coloring effect, the content of the colorant is preferably equal to or more than 0.05 phr, and preferably equal to or more than 0.1 phr based on the total mass of the components other than the colorant. From the viewpoint of reducing the excess amount of the colorant while obtaining a sufficient coloring effect, the content of the colorant is preferably equal to or less than 5 phr, more preferably equal to or less than 3 phr, and still more preferably equal to or less than 2 phr. From the viewpoint of appearance such as glossiness, the content of the colorant is preferably equal to or less than 1 phr, more preferably equal to or less than 0.3 phr, still more preferably equal to or less than 0.2 phr, and particularly preferably equal to or less than 0.1 phr. These colorants can be used singly or in combination of two or more thereof.

The resin composition may contain, as the other components, additives commonly used for conventional molding resin materials as long as the object of the present disclosure is not impaired. Examples of such additives include antioxidants such as phenol-based and phosphorus-based antioxidants, light stabilizers, ultraviolet absorbers, antistatic agents, and antibacterial and antifungal agents. In particular, the resin composition may contain an additive commonly used for a conventional cellulose resin.

### [Method for Producing Resin Composition]

A method for producing the resin composition of the present disclosure is not particularly limited, and for example, a resin composition can be obtained by melt-mixing the component A, the component B, and the component C, and as necessary, other components with a conventional mixer. As the mixer, for example, a compounding apparatus such as a tumbler mixer, a ribbon blender, a single-screw or multi-screw mixing extruder, a kneading kneader, or a kneading roll can be used. After the melt mixing, the resulting mixture can be granulated into an appropriate shape as necessary, and for example, the mixture can be pelletized using a pelletizer.

### [Molded Body]

A molded body formed using the resin composition according to the present disclosure can be formed into a desired shape by a conventional molding method. The thickness of the molded body is preferably equal to or more than 0.5 mm, and more preferably equal to or more than 0.8 mm from the viewpoint of the strength, but not particularly limited thereto. Furthermore, from the viewpoint of flame retardancy, the thickness of the molded body is preferably equal to or more than 1.0 mm, more preferably equal to or more than 1.6 mm, more preferably equal to or more than 2.0 mm, and still more preferably equal to or more than 3.2 mm. On the other hand, the upper limit of the thickness of the molded body is also not particularly limited, can be appropriately set according to the required shape, strength, and the like, and can be set to, for example, equal to or less than 10 mm, and furthermore, equal to or less than 5 mm.

The resin composition according to the present disclosure can be formed into a molded body in accordance with the intended use by a conventional molding method such as injection molding, injection compression molding, extrusion molding, or hot press molding.

Since the molded body formed using the resin composition according to the present disclosure is excellent in designability, the molded body can be applied to a housing, an exterior, a decorative plate, a decorative sheet, and the like, and can be used in place of, for example, members used for electronic devices, home electric appliances, building materials, furniture, and automobiles. For example, the molded body can also be used for housings and exterior parts of electronic devices and home electric appliances, interior members of building materials, and interior materials of automobiles.

Examples of the electronic device and home electric appliance applications include housings of personal computers, fixed phones, mobile phone terminals, smartphones, tablets, POS terminals, routers, projectors, speakers, lighting fixtures, copiers, multifunction printers, calculators, remote controllers, refrigerators, washing machines, humidifiers, dehumidifiers, video recorders and players, vacuum cleaners, air conditioners, rice cookers, electric shavers, electric toothbrushes, dishwashers, broadcasting devices, and the like, dial plates and exteriors of watches, and cases of portable terminals such as smartphones.

Automotive applications include interior instrument panels, dashboards, cup holders, door trims, arm rests, door handles, door locks, steering wheels, brake levers, ventilators, shift levers, and the like.

### [2] Part 2

### [Resin Composition]

The resin composition of the present disclosure is
a cellulose-based resin composition comprising:
a component A: cellulose acetate;
a component B: plasticizer (excepting a component D);
a component C: flame retardant (excepting the component B and the component D); and
a component D: a phosphorus-containing organic compound.

### <Component A: Cellulose Acetate>

The resin composition of the present disclosure comprises cellulose acetate as a component A. As cellulose acetate, one in which acetyl groups have been introduced into at least a portion of the hydroxyl groups of cellulose as a raw material can be used.

Cellulose is a linear polymer formed by polymerization of β-D-glucose molecules (β-D-glucopyranose) via β(1→4) glycosidic bonds, as shown in the following formula (1) (wherein n in the formula is a natural number).

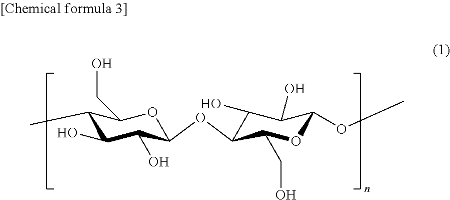

Cellulose is a main component of vegetation, and is obtained by separating other components such as lignin from vegetation. In addition to those obtained in this way, cotton (for example, cotton linters) and pulp (for example, wood pulp) having high cellulose content can be used after purification or as they are. As for the shape, size, and form of the cellulose or a derivative thereof used as a raw material, it is preferable to use cellulose in a powder form having an appropriate particle size and particle shape from the viewpoint of reactivity, solid-liquid separation, and handleability. For example, a fibrous material or a powdery material having a diameter of 1 to 100 μm (preferably 10 to 50 μm) and a length of 10 μm to 100 mm (preferably 100 μm to 10 mm) can be used.

The cellulose has a polymerization degree preferably in the range of 50 to 5,000, more preferably 100 to 3,000, and still more preferably 100 to 1,000 as the polymerization degree of glucose (average polymerization degree). If the polymerization degree is too low, the produced resin may have insufficient strength, heat resistance, and the like. In contrast, if the polymerization degree is too high, the produced resin may have too high a melt viscosity, which may affect the molding.

Each glucose unit that constitutes cellulose has three hydroxy groups. Cellulose acetate in the present disclosure is obtained by introducing acetyl groups into cellulose using these hydroxy groups. Introduction of acetyl groups into cellulose can reduce the intermolecular force (intermolecular bond) of cellulose, and can improve the plasticity of the resin composition.

The acetyl groups can be introduced by a reaction of hydroxy groups in cellulose with an acylating agent. The acetyl groups serve as an organic group moiety introduced in place of hydrogen atoms of the hydroxy groups of cellulose. The acylating agent is a compound having at least one functional group capable of reacting with hydroxy groups in cellulose, and examples thereof include compounds having a carboxyl group, a carboxylic acid halide group, and a carboxylic acid anhydride group. Specific examples include aliphatic monocarboxylic acids, acid halides thereof, and acid anhydrides thereof.

The average number of introduced acetyl groups (DS_{Ac}) per glucose unit of cellulose (acetyl group introduction rate), in other words, the average number of hydroxy groups substituted by acetyl groups per glucose unit (degree of hydroxy group substitution) can be set within the range of 0.1 to 3.0. From the viewpoint of sufficiently obtaining the effect of introducing acetyl groups, in particular, from the viewpoint of water resistance, fluidity, and the like, the DS_{Ac} is preferably equal to or more than 2.0, more preferably equal to or more than 2.2, and still more preferably equal to or more than 2.4. From the viewpoint of sufficiently obtaining the effect of other groups (hydroxy groups and the like) while obtaining the effect of introducing acetyl groups, the DS_{Ac} is preferably equal to or less than 2.9, and more preferably equal to or less than 2.8.

The larger the amount of the remaining hydroxy groups is, the higher the maximum strength and heat resistance of the resin composition tend to be, but the higher the water absorbency tends to be. On the other hand, as the conversion rate (degree of substitution) of hydroxy groups is higher, the water absorbency tends to decrease, leading to an increase in the plasticity and breaking strain, while the maximum strength and heat resistance tend to decrease. The conversion rate of hydroxy groups can be appropriately set in consideration of these tendencies and the like.

The average number of remaining hydroxy groups per glucose unit (residual degree of hydroxy groups) of cellulose acetate can be set within the range of 0 to 2.9. Hydroxy groups may remain from the viewpoint of the maximum strength, heat resistance, and the like of the resin composition, and for example, the residual degree of hydroxy groups may be equal to or more than 0.01, and may further be equal to or more than 0.1. In particular, from the viewpoint of fluidity of the resin composition, the residual degree of hydroxy groups of the finally produced cellulose acetate is preferably equal to or less than 1.0, still more preferably equal to or less than 0.8, and particularly preferably equal to or less than 0.6. From the viewpoint of water resistance, impact resistance, and the like in addition to fluidity of the resin composition, the residual degree of hydroxy groups is preferably equal to or less than 0.6, more preferably equal to or less than 0.5, still more preferably equal to or less than 0.4, and particularly preferably equal to or less than 0.2.

The molecular weight of cellulose acetate is preferably within the range of 10,000 to 400,000, more preferably within the range of 50,000 to 350,000, still more preferably within the range of 100,000 to 300,000, and even still more preferably within the range of 150,000 to 250,000 as the weight-average molecular weight. If the molecular weight is too high, the resin composition may exhibit low fluidity, resulting in difficulties in uniform mixing as well as in processing. In contrast, if the molecular weight is too low, physical properties such as impact resistance of the resin composition may be deteriorated. The weight-average molecular weight can be determined by gel permeation chromatography (GPC) (commercially available standard polystyrene can be used as a standard sample).

In the resin composition of the present disclosure, the content of the component A is preferably equal to or more than 30 mass %, more preferably equal to or more than 35 mass %, and particularly preferably equal to or more than 40 mass % based on 100 mass % of the total content of the components A, B, C, and D. The content is also preferably equal to or less than 80 mass %, more preferably equal to or less than 75 mass %, and particularly preferably equal to or less than 70 mass %, based on 100 mass % of the total content of the components A, B, C, and D.

### <Component B: Plasticizer>

The resin composition of the present disclosure contains a plasticizer as the component B. The component B may be used singly or in combination of two or more thereof. Examples of the component B include, but are not limited to, polyether ester-based plasticizers formed from polyethers such as polyethylene glycol and polypropylene glycol and polyesters derived from dibasic acids such as oxalic acid, malonic acid, succinic acid, glutaric acid, adipic acid, pimelic acid, suberic acid, azelaic acid, sebacic acid, phthalic acid, isophthalic acid, and terephthalic acid; adipate-based plasticizers such as dioctyl adipate and diisononyl adipate; phthalate-based plasticizers such as dibutyl phthalate, diaryl phthalates, diethyl phthalate, dimethyl phthalate, di-2-methoxyethyl phthalate, ethylphthalyl ethyl glycolate, and methylphthalyl ethyl glycolate; tartrate-based plasticizers such as dibutyl tartrate; polyhydric alcohol ester-based plasticizers such as triacetin, diacetyl glycerin, tripropionitrile glycerin, and glyceryl monostearate; aliphatic dicarboxylic acid dialkyl ester-based plasticizers such as dibutyl adipate, dioctyl adipate, dibutyl azelate, dioctyl azelate, and dioctyl sebacate; citrate-based plasticizers such as triethyl citrate, acetyl triethyl citrate, and acetyl tributyl citrate; epoxidized vegetable oil-based plasticizers such as epoxidized soybean oil and epoxidized linseed oil; castor oil and castor oil-derived plasticizers; benzoate-based plasticizers such as ethyl o-benzoylbenzoate; aliphatic dicarboxylic acid ester-based plasticizers such as sebacate esters and azelate esters; unsaturated dicarboxylic acid ester-based plasticizers such as maleate esters; other plasticizers such as N-ethyl toluenesulfonamide, o-cresyl p-toluenesulfonate, and tripropionin.

The plasticizer serving as the component B is not particularly limited as long as it is compatible with cellulose acetate, but in one aspect of the present disclosure, the component B is preferably triethyl citrate. In another aspect of the present disclosure, the component B is preferably a polyether ester-based plasticizer.

In the resin composition of the present disclosure, the content of the component B is preferably equal to or more than 5 mass %, more preferably equal to or more than 10 mass %, and particularly preferably equal to or more than 15 mass % based on 100 mass % of the total content of the components A and B. The content of the component B is also preferably equal to or less than 40 mass %, more preferably equal to or less than 35 mass %, and particularly preferably equal to or less than 30 mass %, based on 100 mass % of the total content of the components A and B.

In the resin composition of the present disclosure, the content of the component B is preferably equal to or more than 2 mass %, more preferably equal to or more than 3 mass %, and particularly preferably equal to or more than 4 mass % based on 100 mass % of the total content of the components A, B, C, and D. The content of the component B is also preferably equal to or less than 20 mass %, more preferably equal to or less than 15 mass %, and particularly preferably equal to or less than 10 mass %, based on 100 mass % of the total content of the components A, B, C, and D. When the content of the component B is within the range, it is possible to obtain, by using the resin composition, a molded body that exhibits excellent flame retardancy and strength and has minimized exudation (bleed-out). If the content of the component B is too large, exudation from the molded body may occur in a high temperature and high humidity environment, and if the content of the component B is too small, the strength may be insufficient.

### <Component C: Flame Retardant>

The resin composition of the present disclosure contains a flame retardant as the component C. The component C may be used singly or in combination of two or more thereof. The component C is not particularly limited, and a nitrogen-containing flame retardant; a phosphorus-based inorganic flame retardant; a halogen-based flame retardant; a boron-based flame retardant or the like can be used.

Examples of the nitrogen-containing flame retardant include, but are not limited to, ammonium polyphosphate, melamine sulfate, guanidine phosphate, melamine polyphosphate, piperazine pyrophosphate, and melamine cyanurate. Ammonium polyphosphate microencapsulated with a melamine resin or the like can be used from the viewpoint of improving water resistance.

Examples of the phosphorus-based inorganic flame retardant include, but are not limited to, red phosphorus and ammonium polyphosphate.

Examples of the halogen-based flame retardant include tetrabromobisphenol A (TBBA) compounds; polybenzene ring compounds such as 1,2-bis(2,4,6-tribromophenoxy) ethane, 2,4,6-tris(2,4,6-tribromophenoxy)-1,3,5-triazine, 2,6-dibromophenol, and 2,4-dibromophenol; brominated styrene compounds such as brominated polystyrene and polybrominated styrene; phthalic acid compounds such as ethylene bistetrabromophthalimide; cycloaliphatic compounds such as hexabromocyclododecane; chlorinated paraffin, chlorinated polyethylene, dodecachloropentacyclooctadeca-7,15-diene, and chlorendic anhydride.

Examples of the boron-based flame retardant include borax; boron oxides such as diboron trioxide, boron trioxide, diboron dioxide, tetraboron trioxide, and tetraboron pentoxide; borate compounds such as boric acid, lithium borate, sodium borate, potassium borate, cesium borate, magnesium borate, calcium borate, barium borate, zirconium borate, zinc borate, aluminum borate, and ammonium borate.

From the viewpoint of flame retardancy and strength, the component C is preferably a nitrogen-containing flame retardant, still more preferably at least one selected from the group consisting of ammonium polyphosphate, melamine sulfate, guanidine phosphate, melamine polyphosphate, piperazine pyrophosphate, and melamine cyanurate, and particularly preferably melamine cyanurate.

In the resin composition of the present disclosure, the content of the component C is preferably equal to or more than 5 mass %, more preferably equal to or more than 10 mass %, and particularly preferably equal to or more than 15 mass % based on 100 mass % of the total content of the components A, B, C, and D. The content of the component C is also preferably equal to or less than 35 mass %, more preferably equal to or less than 30 mass %, and particularly preferably equal to or less than 25 mass %, based on 100 mass % of the total content of the components A, B, C, and D. When the content of the component C is within the range, it is possible to obtain, by using the resin composition, a molded body that exhibits excellent flame retardancy and strength. If the content of the component C is too large, moldability may be deteriorated or toughness (Charpy impact value) may be deteriorated. If the content of the component C is too small, flame retardancy may be insufficient.

### <Component D: Phosphorus-Containing Organic Compound>

The resin composition of the present disclosure contains a phosphorus-containing organic compound as the component D. The component D may be used singly or in combination of two or more thereof. Examples of the component D include, but are not limited to, one or more phosphate esters selected from the group consisting of triphenyl phosphate (TPP), triethyl phosphate, tributyl phosphate, tricresyl phosphate, cresyl di-2,6-xylenyl phosphate, and a compound represented by the following Formula (2).

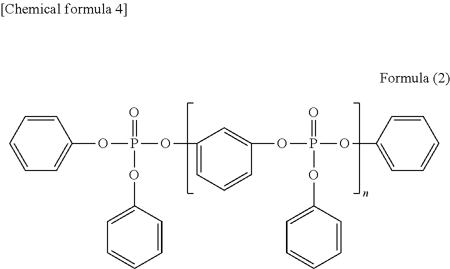

(n is an integer equal to or greater than 1)

In the above-described Formula (2), n is an integer of 1 or more, preferably 1 to 3, and more preferably n=1. The use of the phosphorus-containing organic compound enables the formation of a resin composition having high strength.

In one aspect of the present disclosure, the component D is more preferably triphenyl phosphate from the viewpoint of flame retardancy and high compatibility with cellulose acetate.

In the resin composition of the present disclosure, the content of the component D is preferably equal to or more than 5 mass %, more preferably equal to or more than 6 mass %, and particularly preferably equal to or more than 7 mass % based on 100 mass % of the total content of the components A, B, C, and D. The content of the component D is also preferably equal to or less than 20 mass %, more preferably equal to or less than 15 mass %, and particularly preferably equal to or less than 10 mass %, based on 100 mass % of the total content of the components A, B, C, and D. When the content of the component D is within the range, it is possible to obtain, by using the resin composition, a molded body that exhibits excellent flame retardancy and strength and has minimized exudation (bleed-out). If the content of the component D is too large, exudation from the molded body may occur in a high temperature and high humidity environment, and if the content of the component D is too small, the flame retardancy may be insufficient.

In the resin composition of the present disclosure, the total content of the component B and component D is preferably equal to or more than 20 mass %, more preferably equal to or more than 22 mass %, and particularly preferably equal to or more than 23 mass % based on 100 mass % of the total content of the components A, B, and D. The content is also preferably equal to or less than 50 mass %, more preferably equal to or less than 45 mass %, and particularly preferably equal to or less than 40 mass %, based on 100 mass % of the total content of the components A, B, and D. When the total content of the component B and component D is within the range, it is possible to obtain, by using the resin composition, a molded body that exhibits excellent flame retardancy and strength and has minimized exudation (bleed-out). If the total content of the component B and component D is too large, exudation from the molded body may occur in a high temperature and high humidity environment, and if the total content of the component B and component D is too small, the strength, flame retardancy or fluidity may be insufficient.

In the resin composition of the present disclosure, the total content of the component C and component D is preferably equal to or more than 20 mass %, more preferably equal to or more than 25 mass %, and particularly preferably equal to or more than 28 mass % based on 100 mass % of the total content of the components A, B, C, and D. The content is also preferably equal to or less than 45 mass %, more preferably equal to or less than 40 mass %, and particularly preferably equal to or less than 35 mass %, based on 100 mass % of the total content of the components A, B, C, and D. When the total content of the component C and component D is within the range, it is possible to obtain, by using the resin composition, a molded body that exhibits excellent flame retardancy and strength and has minimized exudation (bleed-out). If the total content of the component C and component D is too large, moldability may be deteriorated or toughness (Charpy impact value) may be deteriorated. If the total content of the component C and component D is too small, flame retardancy may be insufficient.

### <Inorganic or Organic Granular or Fibrous Fillers>

In one aspect of the present example embodiment, the resin composition preferably contains an inorganic- or organic-based particulate or fibrous filler, and particularly preferably contains glass fiber. Inclusion of the inorganic- or organic-based particulate or fibrous filler in the resin composition can improve the strength of the molded body.

The glass fiber is not particularly limited, but the fiber length of the glass fiber is preferably equal to or more than 0.5 mm, and preferably equal to or less than 30 mm and more preferably equal to or less than 10 mm in the shape before melt-kneading. The cross-sectional shape of the glass fiber is not particularly limited, and examples thereof include a circular shape, an elliptical shape, an oval shape, and a non-circular shape. The fiber diameter of the glass fiber may be, for example, 3 to 20 μm when the cross-sectional area is converted into a perfect circle.

Examples of the inorganic- or organic-based particulate or fibrous filler other than glass fiber include mineral matter particles (such as talc, mica, calcined siliceous earth, kaolin, sericite, bentonite, smectite, clay, silica, quartz powder, glass beads, glass powder, glass flakes, milled fibers, and wollastonite), boron-containing compounds (such as boron nitride, boron carbide, and titanium boride), metal carbonates (such as magnesium carbonate, heavy calcium carbonate, and light calcium carbonate), metal silicates (such as calcium silicate, aluminum silicate, magnesium silicate, and magnesium aluminosilicate), metal oxides (such as magnesium oxide), metal sulfates (such as calcium sulfate and barium sulfate), metal carbides (such as silicon carbide, aluminum carbide, and titanium carbide), metal nitrides (such as aluminum nitride, silicon nitride, and titanium nitride), white carbon, and various metal foils. Examples of the fibrous filler include organic fibers (such as natural fibers and paper), inorganic fibers (such as asbestos fibers, carbon fibers, silica fibers, silica alumina fibers, wollastonite, zirconia fibers, and potassium titanate fibers), and metal fibers.

In one aspect of the present example embodiment, the content of the inorganic- or organic-based particulate or fibrous filler based on the total mass of the resin composition may be 0 mass %, but is, for example, preferably equal to or more than 5 mass %, more preferably equal to or more than 10 mass %, and still more preferably equal to or more than 15 mass %, and is preferably equal to or less than 40 mass %, more preferably equal to or less than 30 mass %, and still more preferably equal to or less than 25 mass %. When the content of the inorganic- or organic-based particulate or fibrous filler is within the range, the effect of improving the strength of the resin composition can be sufficiently obtained.

### <Hydrolysis Inhibitor>

In one aspect of the present example embodiment, the resin composition may contain a hydrolysis inhibitor. The hydrolysis inhibitor refers to a compound capable of reacting with a carboxylic acid generated by hydrolysis of cellulose acetate or polyester. Inclusion of the hydrolysis inhibitor in the resin composition can improve the durability and the like of the molded body.

Examples of the hydrolysis inhibitor include compounds having functional groups such as a carbodiimide group, an epoxy group, and an oxazoline group, and a carbodiimide compound having a carbodiimide group is preferable.

The carbodiimide compound is a compound having one or more carbodiimide groups (—N═C═N—) in the molecule. The carbodiimide compound may be a compound containing two or more carbodiimide groups in the molecule, that is, a polyvalent carbodiimide compound. In one aspect, the number of carbodiimide groups in the polyvalent carbodiimide compound is preferably equal to or less than 30 in the carbodiimide compound. As the carbodiimide compound, a high molecular weight polycarbodiimide produced by a decarboxylative condensation reaction of diisocyanate in the presence of a carbodiimide catalyst may be used.

Examples of the carbodiimide compound include monocarbodiimides such as aliphatic monocarbodiimide, alicyclic monocarbodiimide, and aromatic monocarbodiimide, and polycarbodiimides such as aliphatic polycarbodiimide, alicyclic polycarbodiimide, and aromatic polycarbodiimide.

Examples of the aliphatic monocarbodiimide include diisopropylcarbodiimide, dimethylcarbodiimide, diisobutylcarbodiimide, and dioctylcarbodiimide. Examples of the alicyclic monocarbodiimide include dicyclohexylcarbodiimide. Examples of the aromatic monocarbodiimide include N,N′-diphenylcarbodiimide and N,N′-di-2,6-diisopropylphenylcarbodiimide.

Examples of the polycarbodiimide include those obtained by decarboxylative condensation reaction of the following diisocyanates. Examples of the diisocyanates include 1,4-phenylene diisocyanate, 1,3,5-triisopropyl-phenylene-2,4-diisocyanate, 4,4′-diphenylmethane diisocyanate, 3,3′-dimethoxy-4,4′-diphenylmethane diisocyanate, 3,3′-dimethyl-4,4′-diphenylmethane diisocyanate, 4,4′-diphenylether diisocyanate, 3,3′-dimethyl-4,4′-diphenylether diisocyanate, 2,4-tolylene diisocyanate, 2,6-tolylene diisocyanate, 1-methoxyphenyl-2,4-diisocyanate, isophorone diisocyanate, 4,4′-dicyclohexylmethane diisocyanate, and tetramethylxylylene diisocyanate, and these can be used singly or in combination of two or more thereof. Such a high molecular weight polycarbodiimide may be synthesized, or a commercially available product may be used. The number-average molecular weight of the polycarbodiimide is not particularly limited, but for example, it is preferable to use a polycarbodiimide having a number-average molecular weight of preferably equal to or more than 200, more preferably equal to or more than 300, and preferably equal to or less than 20,000.

The carbodiimide compound may be a carbodiimide compound having an isocyanate group in the molecule or a carbodiimide compound having no isocyanate group in the molecule, and can be appropriately selected. In the polycarbodiimide, both ends of the molecule or any moiety in the molecule may have a functional group such as an isocyanate group, or may have a molecular structure different from other portions such as a branched molecular chain. In addition, the carbodiimide compound may have a heterocyclic ring or another functional group in the molecule.

As the carbodiimide compound, a commercially available product may be used, and examples thereof include CARBODILITE (registered trademark) series (for example, CARBODILITE HMV-15CA, HMV-5CA-LC, LA-1) manufactured by Nisshinbo Chemical Inc.; STABAXOL I POWDER, STABAXOL P, and STABAXOL P 100 manufactured by LANXESS AG; and TCC-NP manufactured by Teijin Limited.

Examples of a compound containing an epoxy group include a glycidyl ester compound and a glycidyl ether compound. Examples of a compound containing an oxazoline group include bisoxazoline compounds.

The content of the hydrolysis inhibitor may be 0 mass %, but is, for example, preferably equal to or more than 0.1 mass % and more preferably equal to or more than 0.5 mass %, and preferably equal to or less than 3 mass % and more preferably equal to or less than 1 mass %, based on 100 mass % of the total amount of the resin composition. The hydrolysis inhibitors may be used singly or in combination of two or more thereof.

### <Flame Retardant Aid (Anti-Drip Agent)>

The resin composition of the present disclosure preferably further contains a flame retardant aid. The inclusion of the flame retardant aid prevents flame propagation caused by shrinkage of the resin composition and melt dropping (dripping) of the resin during heating.

Examples of the flame retardant aid include polytetrafluoroethylene, a tetrafluoroethylene-based copolymer (for example, a tetrafluoroethylene/hexafluoropropylene copolymer or the like), fluorine-based resins such as acrylic-modified polytetrafluoroethylene, polyvinylidene fluoride, and polyhexafluoropropylene, and perfluoroalkanesulfonic acid alkali metal salt compounds and perfluoroalkanesulfonic acid alkaline earth metal salts such as sodium perfluoromethanesulfonate, potassium perfluoro-n-butanesulfonate, potassium perfluoro-t-butanesulfonate, sodium perfluorooctanesulfonate, and calcium perfluoro-2-ethylhexanesulfonate. As the fluorine-containing polymer, various forms of fluoropolymers such as a fluoropolymer in a fine powder form, a fluoropolymer aqueous dispersion, a mixture of a fluoropolymer in a powder form and an acrylonitrile-styrene copolymer, and a mixture of a fluoropolymer in a powder form and polymethyl methacrylate can also be used. Similarly, silicone compounds such as silicone rubbers and layered silicates such as talc may be blended as the other flame retardant aids. These may be used singly or in combination of two or more thereof.

As the flame retardant aid, a fluorine-based flame retardant aid that forms a fiber structure (fibrillar structure) in the resin composition is preferable, and polytetrafluoroethylene is particularly preferable. It is possible to enhance the effect of minimizing the dripping phenomenon during combustion by blending the fluorine-based flame retardant aid. The molecular weight of the fluorine-based flame retardant aid (particularly, polytetrafluoroethylene) is preferably 1,000,000 to 10,000,000 and more preferably 2,000,000 to 9,000,000 in terms of a number-average molecular weight determined from a standard specific gravity. Such polytetrafluoroethylene may be in the form of a solid or an aqueous dispersion.

In the resin composition of the present disclosure, the content of the flame retardant aid is preferably equal to or more than 0.01 mass %, more preferably equal to or more than 0.02 mass %, and still more preferably equal to or more than 0.05 mass %, and the content of the flame retardant aid is also preferably equal to or less than 3 mass %, more preferably equal to or less than 2 mass %, still more preferably equal to or less than 1 mass %, and still more preferably equal to or less than 0.2 mass %, based on 100 mass % of the total amount of the resin composition. When the content of the flame retardant aid is within the range, the flame retardancy is further improved.

### <Copolymer Having Polar Functional Group>

The resin composition of the present disclosure may contain a copolymer having a polar functional group. The copolymer having a polar functional group may be used singly or in combination of two or more thereof. Examples of the polar functional group include, but are not limited to, a maleic anhydride group, an amino group, a quaternary ammonium group, an epoxy group, a carboxyl group, a sulfo group, a phosphoric acid group, a hydroxyl group, a nitro group, and a thiol group, and a maleic anhydride group is preferable. The copolymer may be any of an alternating copolymer, a random copolymer, a block copolymer, and a graft copolymer, and examples thereof include an ethylene copolymer, a propylene copolymer, and a butene copolymer, and an ethylene copolymer is preferable.

In one aspect of the present disclosure, the copolymer having a polar functional group is preferably a maleic anhydride-modified hydrogenated styrene-based thermoplastic elastomer (specifically, a maleic anhydride-modified styrene-ethylene-butylene-styrene block copolymer (SEBS)). In another aspect of the present disclosure, the component E is preferably an ethylene-acrylic ester-maleic anhydride terpolymer.

In the resin composition of the present disclosure, the content of the copolymer having a polar functional group may be 0 mass %, but is preferably 0.01 to 5 mass %, more preferably 0.05 to 4 mass %, and particularly preferably 0.1 to 3 mass %, based on 100 mass % of the total amount of the resin composition. When the content of the copolymer having a polar functional group is within the range, a molded body further excellent in strength can be obtained.

### <Colorant>

In one aspect of the present disclosure, the resin composition may contain a colorant such as a black colorant. The content of the colorant such as a black colorant can be set within the range of, for example, 0.01 to 10 phr based on the total mass of the components other than the colorant (the content of the colorant is 0.01 to 10 parts by mass based on 100 parts by mass in the total mass of the components of the resin composition other than the colorant), but not limited thereto. From the viewpoint of obtaining a sufficient coloring effect, the content of the colorant is preferably equal to or more than 0.05 phr, and preferably equal to or more than 0.1 phr based on the total mass of the components other than the colorant. From the viewpoint of reducing the excess amount of the colorant while obtaining a sufficient coloring effect, the content of the colorant is preferably equal to or less than 5 phr, more preferably equal to or less than 3 phr, and still more preferably equal to or less than 2 phr. From the viewpoint of appearance such as glossiness, the content of the colorant is preferably equal to or less than 1 phr, more preferably equal to or less than 0.3 phr, still more preferably equal to or less than 0.2 phr, and particularly preferably equal to or less than 0.1 phr. These colorants can be used singly or in combination of two or more thereof.

The resin composition may contain, as the other components, additives commonly used for conventional molding resin materials as long as the object of the present disclosure is not impaired. Examples of such additives include antioxidants such as phenol-based and phosphorus-based antioxidants, light stabilizers, ultraviolet absorbers, antistatic agents, and antibacterial and antifungal agents. In particular, the resin composition may contain an additive commonly used for a conventional cellulose resin.

### [Method for Producing Resin Composition]

A method for producing the resin composition of the present disclosure is not particularly limited, and for example, a resin composition can be obtained by melt-mixing the component A, the component B, the component C, and the component D, and as necessary, other components with a conventional mixer. As the mixer, for example, a compounding apparatus such as a tumbler mixer, a ribbon blender, a single-screw or multi-screw mixing extruder, a kneading kneader, or a kneading roll can be used. After the melt mixing, the resulting mixture can be granulated into an appropriate shape as necessary, and for example, the mixture can be pelletized using a pelletizer.

### [Molded Body]

A molded body formed using the resin composition according to the present disclosure can be formed into a desired shape by a conventional molding method. The thickness of the molded body is preferably equal to or more than 0.5 mm, and more preferably equal to or more than 0.8 mm from the viewpoint of the strength, but not particularly limited thereto. Furthermore, from the viewpoint of flame retardancy, the thickness of the molded body is preferably equal to or more than 1.0 mm, more preferably equal to or more than 1.6 mm, more preferably equal to or more than 2.0 mm, and still more preferably equal to or more than 3.2 mm. On the other hand, the upper limit of the thickness of the molded body is also not particularly limited, can be appropriately set according to the required shape, strength, and the like, and can be set to, for example, equal to or less than 10 mm, and furthermore, equal to or less than 5 mm.

The resin composition according to the present disclosure can be formed into a molded body in accordance with the intended use by a conventional molding method such as injection molding, injection compression molding, extrusion molding, or hot press molding.

Since the molded body formed using the resin composition according to the present disclosure is excellent in designability, the molded body can be applied to a housing, an exterior, a decorative plate, a decorative sheet, and the like, and can be used in place of, for example, members used for electronic devices, home electric appliances, building materials, furniture, and automobiles. For example, the molded body can also be used for housings and exterior parts of electronic devices and home electric appliances, interior members of building materials, and interior materials of automobiles.

Examples of the electronic device and home electric appliance applications include housings of personal computers, fixed phones, mobile phone terminals, smartphones, tablets, POS terminals, routers, projectors, speakers, lighting fixtures, copiers, multifunction printers, calculators, remote controllers, refrigerators, washing machines, humidifiers, dehumidifiers, video recorders and players, vacuum cleaners, air conditioners, rice cookers, electric shavers, electric toothbrushes, dishwashers, broadcasting devices, and the like, dial plates and exteriors of watches, and cases of portable terminals such as smartphones.

Automotive applications include interior instrument panels, dashboards, cup holders, door trims, arm rests, door handles, door locks, steering wheels, brake levers, ventilators, shift levers, and the like.

### Examples

The present disclosure will be described in more detail below with reference to specific examples, but the present disclosure is not limited to these.

### [1] Part 1

Components used for producing resin compositions of examples and comparative examples are listed below.

### [Components of Resin Composition]

Components used for producing resin compositions of Examples are listed below.

### <Component A: Cellulose Acetate>

(a1) Cellulose acetate (manufactured by Daicel Corporation, product name: L-50, acetyl group introduction rate (degree of substitution) DS=2.4, acetylation degree: 55%, polymerization degree based on 6% viscosity: 180)

### <Component B: Plasticizer>

(b1) Triphenyl phosphate (manufactured by DAIHACHI CHEMICAL INDUSTRY CO., LTD., product name: TPP)

(b2) Polyether ester-based plasticizer (manufactured by ADEKA Corporation, product name: ADK CIZER RS-1000)

### <Component C: Nitrogen-Based Flame Retardant>

(c1) Ammonium polyphosphate (manufactured by Taihei Chemical Industrial Co., Ltd., product name: TAIEN C=2)

(c2) Mixture of ammonium polyphosphate, melamine, and pentaerythritol (manufactured by Taihei Chemical Industrial Co., Ltd., product name: TAIEN E)

(c3) Melamine sulfate (manufactured by Sanwa Chemical Co., Ltd., product name: Apinon-901)

(c4) Guanidine phosphate (manufactured by Sanwa Chemical Co., Ltd., product name: Apinon-303)

### <Inorganic-Based Flame Retardant>

Aluminum hydroxide (manufactured by Nippon Light Metal Co., Ltd., product name: BE023) (average particle size: 2 μm)

### <Flame Retardant Aid>

Polytetrafluoroethylene (manufactured by DAIKIN INDUSTRIES, LTD., product name: POLYFLON MPA FA-500H)

### <Hydrolysis Inhibitor>

Carbodiimide (manufactured by Nisshinbo Chemical Inc., product name: CARBODILITE HMV-15CA)

### <Inorganic-Based Fibrous Filler>

Glass fiber (manufactured by Nitto Boseki Co., Ltd., product name: chopped strand CSG 3J-820, fiber length of 3 mm, and flat fibers with an equivalent fiber diameter of approximately 11 μm)

### [Production of Molded Body]

The constituent materials were sufficiently mixed by hand mixing at each of the blending proportions shown in Table 2. The unit of the numerical value related to the blending proportions is mass % based on the entire composition.

The obtained mixture was charged into a co-rotating twin screw extruder (manufactured by STEER World Pvt. Ltd., product name: Omega30H [φ30 and L/D=60]), kneaded at a kneading temperature of 200° C. and a rotation speed of 120 rpm, and collected by water cooling to be pelletized.

The obtained pellets were dried again at 80° C. for 5 hours immediately before molding, and used to prepare molded bodies (evaluation samples) having a predetermined dimension by an injection molding machine (manufactured by TOSHIBA MACHINE CO., LTD., product name: EC20P).

### [Evaluation Test]

The prepared evaluation samples were subjected to the following evaluations.

### <Flame Retardancy (UL94 V Test)>

A flammability test was performed in accordance with the UL94 test (a flammability test of a plastic material for a component in an apparatus) defined by Underwriters Laboratories after leaving test pieces (evaluation samples 1 and 2) for the flammability test, which were obtained by injection molding, in a thermostatic chamber at a temperature of 23° C. and a humidity of 50% for 48 hours. UL94 V is a method for evaluating flame retardancy, in which a test piece with a predetermined size is held vertically, the lower end is exposed to a burner flame (20±1 mm flame) for 10 seconds, the subsequent burning time and dripping behavior are then measured to evaluate flame retardancy. The test pieces are classified into grades of V-0, V-1, and V-2, in descending order of flame retardancy. When the evaluation result is V-2 or higher, it is determined that the flame retardancy is good, and when the evaluation result does not satisfy V-2, it is determined to be non-compliant in terms of flame retardancy. V-0, V-1, and V-2 are as shown in Table 1 below.
(Evaluation sample 1): length of 125 mm, width of 13 mm, thickness of 2.5 mm
(Evaluation sample 2): length of 125 mm, width of 13 mm, thickness of 1.6 mm

TABLE 1

| | | | |
|---|---|---|---|
| Judgement Item | V-0 | V-1 | V-2 |

| | | | | |
|---|---|---|---|---|
| Judgement 1 | [symbol] | [symbol] | [symbol] | [symbol] |
| | [symbol] | | | |
| Judgement 2 | [symbol] | [symbol] | [symbol] | [symbol] |
| Judgement 3 | [symbol] | [symbol] | [symbol] | [symbol] |
| | [symbol] | | | |
| Judgement 4 | [symbol] | No | No | No |
| | [symbol] | | | |
| Judgement 5 | [symbol] | No | No | Yes |

[symbol]

[symbol]

[symbol]

[symbol]

indicates data missing or illegible when filed

The flaming combustion time is a length of time during which the test piece continues flaming combustion after an ignition source (burner) is moved away from the test piece. t1 is the combustion time after the first flame contact, t2 is the combustion time after the second flame contact, and t3 is afterglow (flame-free combustion) time after the second flame contact. In a case where the flame disappears after the first flame contact, the second flame contact is performed by contacting the flame of the burner immediately to the test piece for 10 seconds. In addition, the ignition of the cotton by the dripping is determined by whether the cotton used for the marking positioned at 300±10 mm below the lower end of the test piece is ignited by the dropping (dripping) materials from the test piece.

### <Charpy Impact Value Test>

A Charpy impact test was performed according to JIS K7111-1 (with notches: type A (notch cutter tip R0.25 mm)) using an evaluation sample having a test piece 1A shape specified in JIS K 7162.

TABLE 2

| | | Test examples | | | | | | |
|---|---|---|---|---|---|---|---|---|
| | | 1 | 2 | 3 | 4 | 5 | 6 | 7 |
| Component A | (a1) Cellulose Acetate | 69.70 | 69.70 | 69.70 | 69.70 | 69.70 | 77.40 | [symbol] |
| Component B: | (b1) Triphenyl phosphate | 20.20 | 20.20 | 20.20 | 20.20 | 20.20 | 22.50 | 7.43 |
| Plasticizer | (b2) Poly [symbol] placticizer | — | — | — | — | — | — | 14.85 |
| Component C: | (c1) [symbol] | 10.00 | — | — | — | — | — | 20.00 |
| [symbol] | (c2) Mixture of [symbol] | — | 10.00 | — | — | — | — | — |
| based flame [symbol] | polyphosphate, | | | | | | | |
| | [symbol] | | | | | | | |
| | (c3) [symbol] | — | — | 10.00 | — | — | — | — |
| | (c4) [symbol] | — | — | — | 10.00 | — | — | — |
| Inorganic flame retardant | [symbol] | — | — | — | — | 10.00 | — | — |
| Flame retardant aid | [symbol] | 0.10 | 0.10 | 0.10 | 0.10 | 0.10 | 0.10 | — |
| Hydrolysis Inhibitor | Carbodiimide | — | — | — | — | — | — | 0.74 |
| Inorganic fibrous [symbol] | Glass fiber | — | — | — | — | — | — | [symbol] |
| Flame Retardancy | Thickness: 2.5 [symbol] | V-0 | V-0 | V-0 | — | Non- | Non- | — |
| (UL94-V) | | | | | | compliant | compliant | |
| | Thickness: 1.6 [symbol] | — | — | — | — | — | — | V-2 |

| | | | | | | | |
|---|---|---|---|---|---|---|---|
| Charpy inpact value (average value of 5 samples) | 7 | 10 | — | 6 | 5 | — | 4 |

[symbol]

indicates data missing or illegible when filed

As shown in Table 2, in Test Example 6 in which the flame retardant was not used and Test Example 5 in which the inorganic-based flame retardant (aluminum hydroxide) was used, the flame retardancy was poor. On the other hand, in Test Examples 1 to 4 and 7 in which the nitrogen-based flame retardant was used together with cellulose acetate and a plasticizer, it was confirmed that both flame retardancy and strength were achieved. In addition, it was confirmed that the plasticizer may be a phosphate ester, and part or all of the plasticizer may be substituted with a polyether ester-based plasticizer.

### [2] Part 2

Components used for producing resin compositions of examples and comparative examples are listed below.

### [Components of Resin Composition]

Components used for producing resin compositions of Examples are listed below.

### <Component A: Cellulose Acetate>

Cellulose acetate (manufactured by Daicel Corporation, product name: L-50, acetyl group introduction rate (degree of substitution) DS=2.4, acetylation degree: 55%, polymerization degree based on 6% viscosity: 180)

### <Component B: Plasticizer>

Polyether ester-based plasticizer (manufactured by ADEKA Corporation, product name: ADK CIZER RS-1000)

Triethyl citrate (manufactured by Tokyo Chemical Industry Co., Ltd.)

### <Component C: Flame Retardant>

Melamine cyanurate (manufactured by Nissan Chemical Corporation, product name: MC-4500)

### <Component D: Phosphorus-Containing Organic Compound>

Triphenyl phosphate (manufactured by DAIHACHI CHEMICAL INDUSTRY CO., LTD., product name: TPP)

### <Inorganic-Based Fibrous Filler>

Glass fiber (manufactured by Nitto Boseki Co., Ltd., product name: chopped strand CSG 3PA-820, a fiber length of 3 mm, and flat fibers with an equivalent fiber diameter of approximately 15 μm)

### <Flame Retardant Aid>

Polytetrafluoroethylene (manufactured by DAIKIN INDUSTRIES, LTD., product name: POLYFLON MPA FA-500H)

### <Hydrolysis Inhibitor>

Aromatic carbodiimide (manufactured by LANXESS AG, product name: Stabaxol P-100)

### [Production of Molded Body]

The constituent materials were sufficiently mixed by hand mixing at each of the blending proportions shown in Table 4. The unit of the numerical value related to the blending proportions is mass % based on the entire composition.

The obtained mixture was charged into a co-rotating twin screw extruder (manufactured by STEER World Pvt. Ltd., product name: Omega30H [+30 and L/D=60]), kneaded at a kneading temperature of 200° C. and a rotation speed of 240 rpm, and collected by air cooling to be pelletized.

The obtained pellets were dried again at 80° C. for 5 hours immediately before molding, and used to prepare molded bodies (evaluation samples) having a predetermined dimension by an injection molding machine (manufactured by TOSHIBA MACHINE CO., LTD., product name: EC20P).

### [Evaluation Test]

The prepared evaluation samples were subjected to the following evaluations.

### <Flame Retardancy (UL94 V Test)>

A flammability test was performed in accordance with the UL94 test (a flammability test of a plastic material for a component in an apparatus) defined by Underwriters Laboratories after leaving a test piece (evaluation sample) for the flammability test, which was obtained by injection molding, in a thermostatic chamber at a temperature of 23° C. and a humidity of 50% for 48 hours. UL94 V is a method for evaluating flame retardancy, in which a test piece with a predetermined size is held vertically, the lower end is exposed to a burner flame (20±1 mm flame) for 10 seconds, the subsequent burning time and dripping behavior are then measured to evaluate flame retardancy. The test pieces are classified into grades of V-0, V-1, and V-2, in descending order of flame retardancy. When the evaluation result is V-2 or higher, it is determined that the flame retardancy is good, and when the evaluation result does not satisfy V-2, it is determined to be non-compliant in terms of flame retardancy. V-0, V-1, and V-2 are as shown in Table 1 below.
(Evaluation sample): length of 125 mm, width of 13 mm, thickness of 3.2 mm

TABLE 3

| | | | |
|---|---|---|---|
| Judgement Item | V-0 | V-1 | V-2 |

| | | | | |
|---|---|---|---|---|
| Judgement 1 | [symbol] | [symbol] | [symbol] | [symbol] |
| | [symbol] | | | |
| Judgement 2 | [symbol] | [symbol] | [symbol] | [symbol] |
| Judgement 3 | [symbol] | [symbol] | [symbol] | [symbol] |
| | [symbol] | | | |
| Judgement 4 | [symbol] | No | No | No |
| | [symbol] | | | |
| Judgement 5 | [symbol] | No | No | Yes |

[symbol]

[symbol]

[symbol]

[symbol]

indicates data missing or illegible when filed

The flaming combustion time is a length of time during which the test piece continues flaming combustion after an ignition source (burner) is moved away from the test piece. t1 is the combustion time after the first flame contact, t2 is the combustion time after the second flame contact, and t3 is afterglow (flame-free combustion) time after the second flame contact. In a case where the flame disappears after the first flame contact, the second flame contact is performed by contacting the flame of the burner immediately to the test piece for 10 seconds. In addition, the ignition of the cotton by the dripping is determined by whether the cotton used for the marking positioned at 300±10 mm below the lower end of the test piece is ignited by the dropping (dripping) materials from the test piece.

### <Charpy Impact Value Test>

A Charpy impact test was performed according to JIS K7111-1 (with notches: type A (notch cutter tip R0.25 mm)) using an evaluation sample having a test piece 1A shape specified in JIS K 7162.

TABLE 4

| | | Test examples | | | | | | |
|---|---|---|---|---|---|---|---|---|
| | | 8 | 9 | 10 | 11 | 12 | 13 | 14 |
| Component A: Cellulose Acetate | | 45.28 | 40.25 | 49.14 | 49.14 | 45.36 | 40.32 | 40.05 |
| Component B: Plasticizer | Poly [symbol] plasticizer | 5.03 | 10.06 | 5.46 | 5.46 | — | — | — |
| | Triethyl citrate | — | — | — | — | 5.04 | 10.08 | 13.35 |
| Component C: Flame retardant | Melamine cyanurate | 20.00 | 20.00 | 20.00 | 15.00 | 20.00 | 20.00 | 20.00 |
| Component D: Phosphorus- | Triethyl phospate | 8.99 | 8.99 | 9.75 | 9.75 | 9.00 | 9.00 | 6.00 |
| containing organic compound | Glass fiber | 20.00 | 20.00 | 15.00 | 20.00 | 20.00 | 20.00 | 20.00 |
| Hydrolysis Inhibitor | Aromatic Carbodiimides | 0.60 | 0.60 | 0.65 | 0.65 | 0.60 | 0.60 | 0.60 |
| Flame retardant aid | Polytetrafluroethylene | 0.10 | 0.10 | — | — | — | — | — |
| (Anti drip agent) | | | | | | | | |

| | | | | | | | |
|---|---|---|---|---|---|---|---|
| Flame Retardancy (UL94-V) Thickness: 3.1 [symbol] | V-0 | V-1 | V-0 | V-0 | V-0 | V-0 | V-0 |
| Charpy impact value (average value of 5 samples) | 5 | 6 | 4 | 5 | 5 | 6 | 5 |

[symbol]

indicates data missing or illegible when filed

As shown in Table 4, in Test Examples 8 to 14 in which the phosphorus-containing organic compound and the flame retardant were used together with cellulose acetate and a plasticizer, it was confirmed that both flame retardancy and strength were achieved. In Test Examples 10 to 14, the dripping phenomenon during combustion did not occur even though the flame retardant aid (anti-drip agent) was not used, and both flame retardancy and strength were achieved.

Although the present disclosure has been described above with reference to the embodiments and Examples, the present disclosure is not limited to the above embodiments and Examples. Various modifications that can be understood by one skilled in the art can be made to the configuration and details of the present disclosure within the scope of the present disclosure.

A part or all of the above embodiments may be described as the following Supplementary notes, but the disclosure of the present application is not limited to the following Supplementary notes.

### (Supplementary Note 1)

A cellulose-based resin composition comprising:
a component A: cellulose acetate;
a component B: a plasticizer;
a component C: a nitrogen-containing flame retardant;
wherein the content of the component B is 20 to 40 mass % relative to 100 mass % of the total content of the components A and B, and
the content of the component C is 5 to 35 mass % relative to 100 mass % of the total content of the components A, B and C.

### (Supplementary Note 2)

The cellulose-based resin composition according to supplementary note 1, wherein the content of the component C is 5 to 30 mass % relative to 100 mass % of the total content of the components A, B and C.

### (Supplementary Note 3)

The cellulose-based resin composition according to supplementary note 1 or 2, wherein the content of the component A is 35 to 90 mass % relative to 100 mass % of the total content of the components A, B and C.

### (Supplementary Note 4)

The cellulose-based resin composition according to any of preceding supplementary notes, wherein the component B is at least one selected from the group consisting of triphenyl phosphate, triethyl phosphate, tributyl phosphate, tricresyl phosphate, cresyl di-2,6-xylenyl phosphate, a compound represented by the following formula (2) and a polyether ester-based plasticizer.

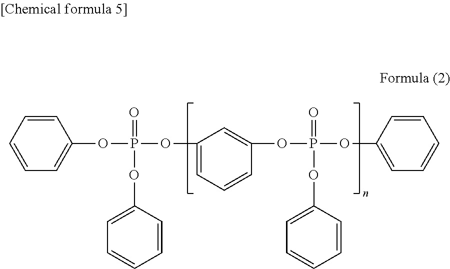

(n is an integer equal to or greater than 1)

### (Supplementary Note 5)

The cellulose-based resin composition according to any of preceding supplementary notes, wherein the content of the component B is 20 to 40 mass % relative to 100 mass % of the total content of the components A and B.

### (Supplementary Note 6)

The resin composition according to any of preceding supplementary notes, wherein the component C is at least one selected from the group consisting of ammonium polyphosphate, melamine sulfate, guanidine phosphate, poly(melamine phosphate), piperazine pyrophosphate, and melamine cyanurate.

### (Supplementary Note 7)

The cellulose-based resin composition according to any of preceding supplementary notes, further comprising a flame retardant aid.

### (Supplementary Note 8)

The cellulose-based resin composition according to supplementary note 7, wherein the content of the flame retardant aid is 0.01 to 2 mass % based on 100 mass % of the total amount of the composition.

### (Supplementary Note 9)

The cellulose-based resin composition according to any of preceding supplementary notes, further comprising inorganic or organic granular or fibrous fillers.

### (Supplementary Note 10)

The cellulose-based resin composition according to supplementary note 9, wherein the content of the inorganic or organic granular or fibrous fillers is 1 to 10 mass % based on 100 mass % of the total amount of the composition.

### (Supplementary Note 11)

The cellulose-based resin composition according to any of preceding supplementary notes, further comprising a hydrolysis inhibitor.

### (Supplementary Note 12)

The cellulose-based resin composition according to supplementary note 11, wherein the content of the hydrolysis inhibitor is 0.1 to 5 mass % based on 100 mass % of the total amount of the composition.

### (Supplementary Note 13)

A molded body formed using the cellulose-based resin composition according to any of preceding supplementary notes.

### (Supplementary Note 14)

A method for producing a cellulose-based resin composition according to any of preceding supplementary notes, by melt mixing components A, B and C, and optionally other components in a mixer.

### (Supplementary Note 15)

A cellulose-based resin composition comprising:
a component A: cellulose acetate;
a component B: a plasticizer (excepting a component D);
a component C: a flame retardant (excepting the component B and the component D); and
a component D: a phosphorus-containing organic compound.

### (Supplementary Note 16)

The cellulose-based resin composition according to supplementary note 15, wherein the content of the component B is 5 to 40 mass % relative to 100 mass % of the total content of the components A and B.

### (Supplementary Note 17)

The resin composition according to supplementary note 15 or 16, wherein the content of the component C is 5 to 35 mass % relative to 100 mass % of the total content of the components A, B, C and D.

### (Supplementary Note 18)

The cellulose-based resin composition according to any of preceding supplementary notes 15 to 17, wherein the content of the component D is 5 to 20 mass % relative to 100 mass % of the total content of the components A, B, C and D.

### (Supplementary Note 19)

The cellulose-based resin composition according to any of preceding supplementary notes 15 to 18, wherein the total content of the components C and D is 20 to 45 mass % relative to 100 mass % of the total content of the components A, B, C and D.

### (Supplementary Note 20)

The cellulose-based resin composition according to any of preceding supplementary notes 15 to 19, wherein the content of the component A is 30 to 80 mass % relative to 100 mass % of the total content of the components A, B, C and D.

### (Supplementary Note 21)

The cellulose-based resin composition according to any of preceding supplementary notes 15 to 20, wherein the component B is triethyl citrate.

### (Supplementary Note 22)

The cellulose-based resin composition according to any of preceding supplementary notes 15 to 20, wherein the component B is a polyether ester-based plasticizer.

### (Supplementary Note 23)

The resin composition according to any of preceding supplementary notes 15 to 22, wherein the component C is a nitrogen-based flame retardant.

### (Supplementary Note 24)

The resin composition according to any of preceding supplementary notes 15 to 23, wherein the component C is at least one selected from the group consisting of ammonium polyphosphate, melamine sulfate, guanidine phosphate, poly(melamine phosphate), piperazine pyrophosphate, and melamine cyanurate.

### (Supplementary Note 25)

The resin composition according to any of preceding supplementary notes 15 to 24, wherein the component C is melamine cyanurate.

### (Supplementary Note 26)

The cellulose-based resin composition according to any of preceding supplementary notes 15 to 25, further comprising a flame retardant aid.

### (Supplementary Note 27)

The cellulose-based resin composition according to supplementary note 26, wherein the content of the flame retardant aid is 0.01 to 3 mass % based on 100 mass % of the total amount of the composition.

### (Supplementary Note 28)

The cellulose-based resin composition according to any of preceding supplementary notes 15 to 27, further comprising inorganic or organic granular or fibrous fillers.

### (Supplementary Note 29)

The cellulose-based resin composition according to any of preceding supplementary note 28, wherein the content of the inorganic or organic granular or fibrous fillers is 5 to 40 mass % based on 100 mass % of the total amount of the composition.

### (Supplementary Note 30)

The cellulose-based resin composition according to any of preceding supplementary notes 15 to 29, further comprising a hydrolysis inhibitor.

### (Supplementary Note 31)

The cellulose-based resin composition according to supplementary note 30, wherein the content of the hydrolysis inhibitor is 0.1 to 3 mass % based on 100 mass % of the total amount of the composition.

### (Supplementary Note 32)

The cellulose-based resin composition according to any of preceding supplementary notes 15 to 31, further comprising a copolymer having a polar functional group.

### (Supplementary Note 33)

The cellulose-based resin composition according to supplementary note 32, wherein the content of the copolymer having a polar functional group is 0.01 to 5 mass % based on 100 mass % of the total amount of the composition.

### (Supplementary Note 34)

A molded body formed using the cellulose-based resin composition according to any of preceding supplementary notes 15 to 33.

### (Supplementary Note 35)

A method for producing a cellulose-based resin composition according to any of preceding supplementary notes 15 to 33, by melt mixing components A, B, C and D, and optionally other components in a mixer.

1. A cellulose-based resin composition comprising:
a component A: cellulose acetate;
a component B: a plasticizer;
a component C: a nitrogen-containing flame retardant;
wherein the content of the component B is 20 to 40 mass % relative to 100 mass % of the total content of the components A and B, and
the content of the component C is 5 to 35 mass % relative to 100 mass % of the total content of the components A, B and C.

2. The cellulose-based resin composition according to claim 1, wherein the content of the component C is 5 to 30 mass % relative to 100 mass % of the total content of the components A, B and C.

3. The cellulose-based resin composition according to claim 1, wherein the component B is at least one selected from the group consisting of triphenyl phosphate, triethyl phosphate, tributyl phosphate, tricresyl phosphate, cresyl di-2,6-xylenyl phosphate, a compound represented by the following formula (2), and a polyether ester-based plasticizer. 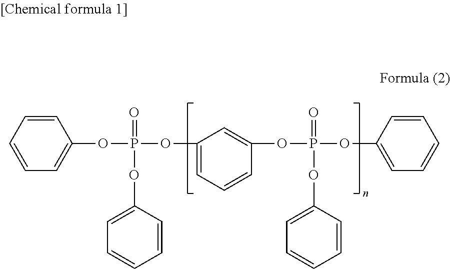
(n is an integer equal to or greater than 1)

4. The cellulose-based resin composition according to claim 1, wherein the component C is at least one selected from the group consisting of ammonium polyphosphate, melamine sulfate, guanidine phosphate, poly(melamine phosphate), piperazine pyrophosphate, and melamine cyanurate.

5. The cellulose-based resin composition according to claim 1, further comprising a flame retardant aid.

6. The cellulose-based resin composition according to claim 1, further comprising inorganic or organic granular or fibrous fillers.

7. The cellulose-based resin composition according to claim 1, further comprising a hydrolysis inhibitor.

8. A molded body formed using the cellulose-based resin composition according to claim 1.

9. A cellulose-based resin composition comprising:
a component A: cellulose acetate;
a component B: a plasticizer (excepting a component D);
a component C: a flame retardant (excepting the component B and the component D); and
a component D: a phosphorus-containing organic compound.

10. The resin composition according to claim 9, wherein the content of the component B is 5 to 40 mass % relative to 100 mass % of the total content of the components A and B.

11. The resin composition according to claim 9, wherein the content of the component C is 5 to 35 mass % relative to 100 mass % of the total content of the components A, B, C and D.

12. The resin composition according to claim 9, wherein the content of the component D is 5 to 20 mass % relative to 100 mass % of the total content of the components A, B, C and D.

13. The resin composition according to claim 9, wherein the total content of the components C and D is 20 to 45 mass % relative to 100 mass % of the total content of the components A, B, C and D.

14. The cellulose-based resin composition according to claim 9, wherein the component B is triethyl citrate.

15. The cellulose-based resin composition according to claim 9, wherein the component B is polyether ester-based plasticizer.

16. The resin composition according to claim 9, wherein the component C is a nitrogen-based flame retardant.

17. The cellulose-based resin composition according to claim 9, further comprising inorganic or organic granular or fibrous fillers.

18. The cellulose-based resin composition according to claim 9, further comprising a hydrolysis inhibitor.

19. The cellulose-based resin composition according to claim 9, further comprising a copolymer having a polar functional group.

20. A molded body formed using the cellulose-based resin composition according to claim 9.
